(19) United States
(12) Patent Application Publication
(10) Pub. No.: US 2025/0196883 A1
(43) Pub. Date: Jun. 19, 2025

(54) SYSTEM AND METHOD OF CONTROLLING DRIVING OF A MOBILITY VEHICLE

(71) Applicants: HYUNDAI MOTOR COMPANY, Seoul (KR); KIA CORPORATION, Seoul (KR)

(72) Inventors: Dong Hwan Kwak, Hwaseong-si (KR); Sanghyeon Oh, Hwaseong-si (KR); Hyuntek Lim, Hwaseong-si (KR)

(73) Assignees: HYUNDAI MOTOR COMPANY, Seoul (KR); KIA CORPORATION, Seoul (KR)

(21) Appl. No.: 18/802,981

(22) Filed: Aug. 13, 2024

(30) Foreign Application Priority Data
Dec. 15, 2023 (KR) 10-2023-0182799

(51) Int. Cl. B60W 60/00

(52) U.S. Cl. CPC B60W 60/001; B60W 2420/408; B60W 2720/10

(57) ABSTRACT

A system for controlling driving of a mobility vehicle may include a front terrain scanning unit configured to detect LiDAR point data and scan a surface image in front of the mobility vehicle, and a driving unit configured to provide power to move the mobility vehicle. The system may further include a controller configured to store a specification of the mobility vehicle including a dynamic radius of each wheel, generate a driving route using the LiDAR point data, detect depth data of a surface based on the surface image, acquire an actual driving route for each wheel using the depth data of the surface within the driving route for each wheel and the dynamic radius of each wheel of the mobility vehicle, generate a driving command for the actual driving route for each wheel, and control an operation of the driving unit according to the generated driving command.

### CROSS-REFERENCE TO RELATED APPLICATION

This application claims the benefit of and priority to Korean Patent Application No. 10-2023-0182799 filed on Dec. 15, 2023, the entire contents of which are hereby incorporated herein by reference.

### TECHNICAL FIELD

The present disclosure relates to a system and a method of controlling driving of a mobility vehicle.

### BACKGROUND

When a mobility vehicle drives on a curved surface, driving distances of left and right wheels required to move straight on a plane view as seen from the top are different from each other. Therefore, if a curvature is not taken into account when driving on a curved plane, the mobility vehicle will not be able to move along a desired route. In some cases, wheels get stuck in a concave place and cannot move at all.

According to the related art, a dynamic suspension is mounted in the mobility vehicle to solve this problem. However, in order to mount the dynamic suspension, hardware of the mobility vehicle should be changed. In addition, mounting a high-performance suspension in a motility vehicle that does not transport people or objects that should not be shaken may excessively increase manufacturing cost compared to the required performance.

The above information disclosed in this Background section is only for to enhance understanding of the background of the disclosure. Therefore, the information in the Background section may contain information that does not form the prior art that is already known to a person of ordinary skill in the art.

### SUMMARY

Aspects of the present disclosure provide a system and a method capable of responding to curved road surfaces by only performing a motor control logic without modifying the hardware.

Further aspects of the present disclosure provide a system and a method of controlling driving of a mobility vehicle that perform speed control and torque control of a motor according to an actual driving route by acquiring surface information of a road surface with a camera and obtaining the actual driving route according to the surface information.

According to an embodiment of the present disclosure, a system for controlling driving of a mobility vehicle is provided. The system includes a front terrain scanning unit configured to detect light detection and ranging (LiDAR) point data in front of the mobility vehicle and scan a surface image in front of the mobility vehicle. The system also includes a driving unit configured to provide power to move the mobility vehicle. The system further includes a controller configured to store a specification of the mobility vehicle including a dynamic radius of each wheel. The controller is also configured to generate a driving route for the mobility vehicle using the LiDAR point data. The controller is additionally configured to detect depth data of a surface based on the surface image in front of the mobility vehicle. The controller is further configured to acquire an actual driving route for each wheel using the depth data of the surface within the driving route for each wheel and the dynamic radius of each wheel of the mobility vehicle. The controller is also configured to generate a driving command for the actual driving route for each wheel. The controller is additionally configured to control an operation of the driving unit according to the generated driving command.

The controller may be further configured to determine whether the driving route for one wheel is appropriate for driving. The controller may also be configured to determine whether the driving routes of a plurality of wheels are appropriate for driving.

The controller may be configured to generate the driving command for the actual driving route for each wheel in response to determining that the driving route for one wheel is appropriate for driving and that the driving routes for the plurality of wheels are appropriate for driving.

The controller may be further configured to regenerate the driving route in response to determining that the driving route for one wheel is not appropriate for driving or determining that the driving routes for the plurality of wheels are not appropriate for driving.

The controller may be configured to determine that the driving route for one wheel is not appropriate for driving in response to determining that the actual driving route for the one wheel is expected to be bent to a preset angle or more.

The controller may be configured to determine that the driving routes for the plurality of wheels are not appropriate for driving in response to determining that a road surface positioned between wheels, among the plurality of wheels, is expected to collide with a bottom surface of the mobility vehicle.

The controller may be configured to generate the driving command for the actual driving route for each wheel by generating a speed command for the actual driving route for each wheel and generating a torque command for the actual driving route for each wheel.

The controller may be configured to generate the speed command for the actual driving route for each wheel based on the actual driving route for each wheel and a target speed command of the mobility vehicle.

The controller may be configured to generate the torque command for the actual driving route for each wheel based on the actual driving route for each wheel and a target torque command of the mobility vehicle.

The controller may be further configured to determine whether the driving command for the actual driving route for each wheel is appropriate. The controller may also be configured to control the driving unit according to the driving command in response to determining that the driving command for the actual driving route for each wheel is appropriate.

The controller may be further configured to regenerate the driving route in response to determining that the driving command for the actual driving route for each wheel is not appropriate.

According to another embodiment of the present disclosure, a method of controlling driving of a mobility vehicle is provided. The method includes detecting a LiDAR point in front of a mobility vehicle by a front terrain scanning unit. The method also includes scanning a surface image in front of the mobility vehicle by the front terrain scanning unit. The method additionally includes generating, by a controller, a driving route for the mobility vehicle using LiDAR point data. The method further includes detecting, by the controller, depth data of a surface in the driving route based on the surface image in front of the mobility vehicle. The method also includes acquiring, by the controller, an actual driving route for each wheel using the depth data of the surface within the driving route for each wheel and a dynamic radius of each wheel of the mobility vehicle. The method further includes generating, by the controller, a driving command for the actual driving route for each wheel. The method additionally includes controlling, by the controller, an operation of the driving unit according to the generated driving command.

The method may further include determining, by the controller, whether the driving route for one wheel is appropriate for driving. The method may also include determining, by the controller, whether the driving routes for a plurality of wheels are appropriate for driving.

Generating the driving command for the actual driving route for each wheel may include generating, by the controller, the driving command in response to determining that the driving route for one wheel is appropriate for driving and that the driving routes for the plurality of wheels are appropriate for driving.

The method may further include regenerating, by the controller, the driving route in response to determining that the driving route for one wheel is not appropriate for driving or determining that the driving routes for the plurality of wheels are not appropriate for driving.

Generating the driving command for the actual driving route for each wheel may include generating a speed command for the actual driving route for each wheel and generating a torque command for the actual driving route for each wheel.

The speed command for the actual driving route for each wheel may be generated based on the actual driving route for each wheel and a target speed command of the mobility vehicle.

The torque command for the actual driving route for each wheel may be generated based on the actual driving route for each wheel and a target torque command of the mobility vehicle.

The method may further include determining, by the controller, that the driving command for the actual driving route for each wheel is appropriate, in which the controlling an operation of the driving unit according to the generated driving command may be performed in response to determining that the driving command is appropriate for the actual driving route for each wheel.

The method may further include regenerating, by the controller, the driving route in response to determining that the driving command for the actual driving route for each wheel is not appropriate.

According to embodiments of the present disclosure, when driving on an uneven road surface, it is possible to reduce an unintended behavior of the mobility vehicle using a motor control without modifying a hardware.

By using the surface information of the road surface, it is possible to prevent the mobility vehicle from being unable to move due to falling into a puddle or getting caught on a bump.

By observing and correcting disturbance factors that may affect the behavior of the mobility vehicle with the camera, it is possible to reduce impact of the disturbance.

Other effects that can be obtained or are expected from embodiments of the present disclosure are explicitly or implicitly described in the detailed description of the present disclosure. In other words, various effects that obtained or expected from embodiments of the present disclosure are disclosed directly or implicitly in the following detailed description.

### BRIEF DESCRIPTION OF THE DRAWINGS

Embodiments of the present disclosure should be more clearly understood by referring to the following description in conjunction with the accompanying drawings, where like reference numerals refer to identical or functionally similar elements.

FIG. 1 is a block diagram of a system for controlling driving of a mobility vehicle, according to an embodiment of the present disclosure.

FIG. 2 is a flowchart of a method for controlling driving of a mobility vehicle, according to an embodiment of the present disclosure.

FIG. 3 is a flowchart of a step or operation of determining whether a driving route is appropriate in the method of FIG. 2, according to an embodiment.

FIG. 4 is a flowchart of a step or operation of generating a driving command in the method of FIG. 2, according to an embodiment.

FIGS. 5A-D show a driving route generated without scanning a surface, a surface within a scanned driving route, and an actual driving route according to a dynamic radius of a tire, according to an embodiment of the present disclosure.

FIGS. 6A and 6B show a driving route appropriate for driving and a driving route inappropriate for driving, according to an embodiment of the present disclosure.

FIGS. 7A-C show a target speed command of a mobility vehicle when driving on a driving route generated without scanning a surface and a speed command of both wheels when driving on an actual driving route, according to an embodiment of the present disclosure.

FIGS. 8A-C show a target torque command of a mobility vehicle when driving on a driving route generated without scanning a surface and a torque command of both wheels when driving on an actual driving route, according to an embodiment of the present disclosure.

It should be understood that the drawings referenced above are not necessarily drawn to scale. The drawings present rather simplified representations of various features illustrating the basic principles of the present disclosure. For example, specific design features of the present disclosure, including specific dimensions, direction, position, and shape, will be determined in part by specific intended applications and use environments.

### DETAILED DESCRIPTION

The terminology used herein is for the purpose of describing particular embodiments. The terminology is not intended to limit the present disclosure. As used herein, singular forms are intended to also include plural forms, unless the context clearly dictates otherwise. The terms “includes,” “including,” “comprises,” “comprising,” “have,” “having,” or the like, specify the presence of the mentioned features, integers, steps, operations, elements, and/or components when used herein. However, it should be understood that these terms do not exclude the presence or addition of one or more of other features, integers, steps, operations, elements, components, and/or groups thereof. As used herein, the term “and/or” includes any one or all combinations of the associated listed items.

As used in this specification, “mobility vehicle” or “of mobility vehicle” or other similar terms are inclusive of motor vehicles in general. Such motor vehicles include passenger vehicles, such as sport utility vehicles (SUVs), buses, trucks, various commercial vehicles, etc. Such motor vehicles also include marine mobility vehicles, such as various types of boats and ships, and aerial mobilities, such as aircraft, drones, etc. Such motor vehicle generally include all objects that may move by receiving power from a power source. In addition, as used in this specification, “mobility vehicle” or “of mobility vehicle” or other similar terms include hybrid mobility vehicles, electric mobility vehicles, plug-in hybrid mobility vehicles, hydrogen-powered mobility vehicles, and other alternative fuel (e.g., fuels derived from resources other than petroleum) mobility vehicles. As described in this specification, the hybrid mobility vehicles include a mobility vehicles having two or more power sources, such as a gasoline powered and electric powered mobility vehicle. Mobility vehicles according to embodiments of the present disclosure include a mobility vehicles driven somewhat autonomously and/or automatically as well as mobility vehicles driven manually.

Additionally, it should be understood that one or more of the methods according to embodiments of the present disclosure or aspects thereof may be executed by at least one or more controllers. The term “controller” may refer to a hardware device including a memory and a processor. The memory is configured to store program instructions, and the processor is specifically programmed to execute the program instructions to perform one or more processes described in more detail below. The controller may control operations of units, modules, parts, devices, or the like, as described herein. It should also be understood that methods according to embodiments of the present disclosure may be executed by an apparatus including a controller in conjunction with one or more other components, as should be recognized by those having ordinary skill in the art.

In addition, the controller of the present disclosure may be implemented as a non-transitory computer-readable recording medium including executable program instructions executable by a processor. Examples of the computer-readable recording medium include ROM, RAM, compact disk (CD) ROM, magnetic tapes, floppy disks, flash drives, smart cards, and/or optical data storage devices. However, the computer readable recording medium is not limited thereto. The computer-readable recording medium may also be distributed across a computer network so that the program instructions may be stored and executed in a distributed manner, for example, on a telematics server or a controller Area Network (CAN).

When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in detail with reference to the accompanying drawings.

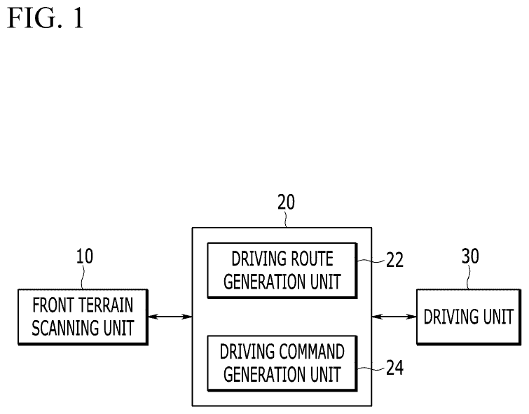

FIG. 1 is a block diagram of a system for controlling driving of a mobility vehicle, according to an embodiment of the present disclosure.

As illustrated in FIG. 1, a system for controlling driving of a mobility vehicle according to an embodiment of the present disclosure includes a front terrain scanning unit 10, a controller 20, and a driving unit 30.

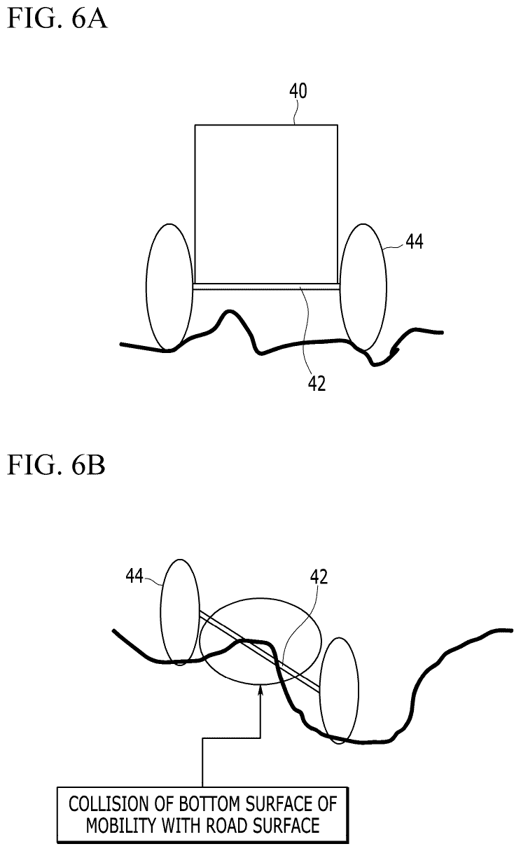

The front terrain scanning unit 10 may be mounted on the mobility vehicle 40 (as illustrated in FIGS. 6A and 6B, for example) and may scan a front terrain of the mobility vehicle 40. The front terrain scanning unit 10 may include a LIDAR and a camera.

The LiDAR may irradiate a laser pulse in front of the mobility vehicle 40 and detect a return time of the laser pulse reflected from an object (for example, fixed terrain and obstacles, etc.) within a detection range of the LiDAR to detect information on the object such as a distance from the LiDAR to the object, a direction, speed, temperature, material distribution, and concentration characteristics of the object. The object may be other mobility vehicles, persons, things, pillars, walls, etc., existing outside the mobility vehicle 40 equipped with the LiDAR. However, the present disclosure is not particularly limited to a type of objects. The LiDAR may be connected to the controller 20 to detect 2D LiDAR point data (e.g., 2D data of a plurality of LiDAR points) within a detection range and transmit the 2D LiDAR point data to the controller 20. However, the LiDAR is not limited to the LiDAR that detects the 2D LiDAR point data. For example, the LiDAR may include a LIDAR that detects 3D LiDAR point data.

The camera may scan an image in front of the mobility vehicle 40 within a detection range of the camera, for example, a surface image in front of the mobility vehicle 40. The camera may be connected to the controller 20 and may transmit the scanned image to the controller 20. The image may be composed of pixel data including a plurality of pixels. The type of the camera is not particularly limited as long as the camera may detect depth data of a surface in front of the mobility vehicle 40 or detect data from which the depth data may be calculated.

The controller 20 includes a driving route generation unit 22 and a driving command generation unit 24.

The driving route generation unit 22 may receive the 2D LiDAR point data from the LiDAR and may receive the surface image of the front of the mobility vehicle 40 from the camera. The driving route generation unit 22 may generate a route for the mobility vehicle 40 using the received 2D LiDAR point data and map data. The driving route generation unit 22 may also detect the depth data of the surface within the route based on the surface image in front of the mobility vehicle 40. The driving route generation unit 22 may acquire an actual driving route for each wheel 44 using the depth data of the surface within the route and a dynamic radius of the wheel 44 of the mobility vehicle 40. The driving route generation unit 22 may evaluate whether the actual driving route is appropriate for driving based on specifications of the mobility vehicle 40 and may transmit, to the driving command generation unit 24, a command to generate driving command according to the actual driving route in response to the evaluation that the driving route is appropriate for driving.

The driving command generation unit 24 may receive the command from the driving route generation unit 22 and may generate the driving command according to the actual driving route. The driving command may include a speed command and a torque command. The driving command generation unit 24 may evaluate whether the driving command is appropriate for the mobility vehicle 40 to drive based on the specifications of the mobility vehicle 40 and may perform the driving control of the mobility vehicle 40 in response to the evaluation that the driving command is appropriate for the mobility vehicle 40 to drive.

In an embodiment, the controller 20 is equipped with one or more microprocessors programmed to perform each step of the method of controlling driving of the mobility vehicle according to embodiments of the present disclosure.

The driving unit 30 may be mounted on the mobility vehicle 40 and may provide power to move the mobility vehicle 40. The operation of the driving unit 30 is controlled by the controller 20. The driving unit 30 may include at least one wheel 44 (as illustrated in FIGS. 6A and 6B, for example) and at least one driving motor for rotating the at least one wheel 44. In one example, each wheel 44 may be equipped with a corresponding drive motor, and each drive motor may independently control the speed and the torque of the corresponding wheel 44. For example, the mobility vehicle 40 may include at least a left wheel 44 and a right wheel 44, and may further include a left drive motor for the left wheel 44 and a right drive motor for the right wheel 44. However, the number of wheels 44 and the number of drive motors included in the driving unit 30 are not particularly limited.

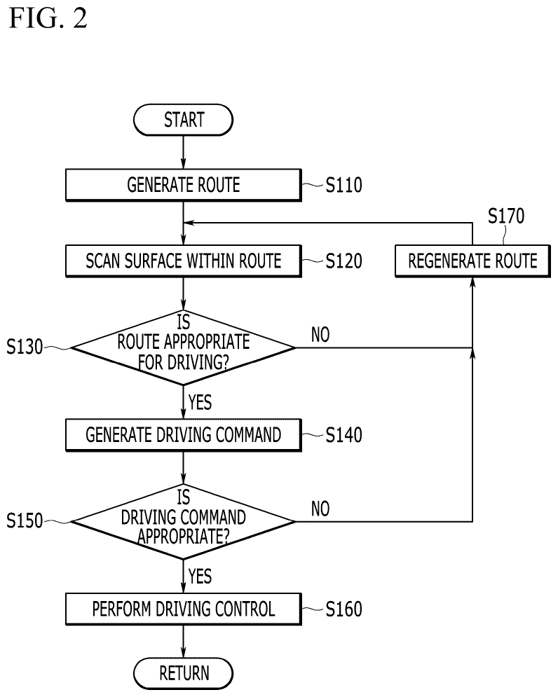

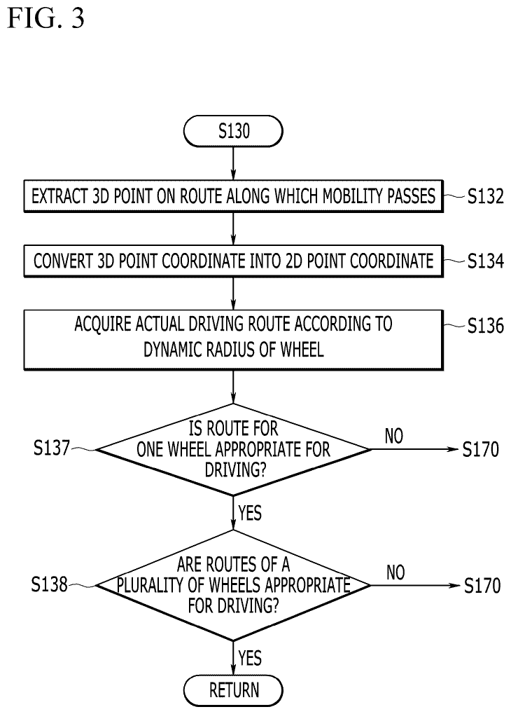

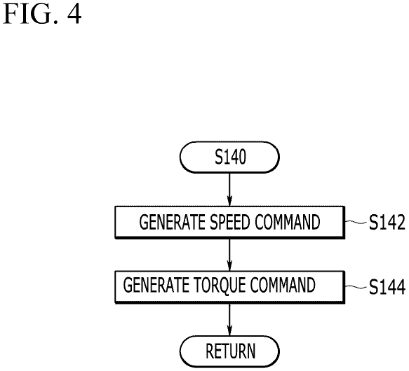

FIG. 2 is a flowchart of a method of controlling driving of a mobility vehicle, according to an embodiment of the present disclosure. FIG. 3 is a flowchart of a step or operation of determining whether a driving route is appropriate in the method of FIG. 2. according to an embodiment. FIG. 4 is a flowchart of a step or operation of generating a driving command in the method of FIG. 2, according to an embodiment.

As illustrated in FIG. 2, the method of controlling driving of a mobility vehicle according to an embodiment of the present disclosure begins when the mobility vehicle 40 is powered on. For example, a user may press a start button of the mobility vehicle 40 or start the mobility vehicle 40 using a remote control device.

The mobility vehicle 40 may receive a destination, etc., from a user. The mobility vehicle 40 may call a map data stored in a memory of the controller 20, or may start creating a map through the front terrain scanning unit 10, etc. For example, the LiDAR detects the 2D LiDAR point data in front of the mobility vehicle 40 and transmits the detected 2D LiDAR point data to the controller 20, and the camera scans the image in front of the mobility vehicle 40 and transmits the scanned image to the controller 20. In a step or operation S110, the driving route generation unit 22 of the controller 20 may detect a position of the mobility vehicle 40 based on the called map data, the 2D LiDAR point data and/or the image in front of the mobility vehicle 40 and may generate the driving route for the mobility vehicle 40 based on the map data, the 2D LiDAR point data, the image in front of the mobility vehicle 40 and/or the position of the mobility vehicle 40. In an embodiment, a logic for generating the driving route for the mobility vehicle 40 is stored in the memory of the controller 20. For example, a plurality of driving routes from the current position of the mobility vehicle 40 to the destination may be calculated, and the driving route with the lowest cost among the plurality of driving routes may be selected. Since logic for generating the driving route for the mobility vehicle 40 is well known to those having ordinary skill in the art, a detailed description thereof has been omitted.

When the driving route generation unit 22 of the controller 20 generates the driving route for the mobility vehicle 40, the driving route generation unit 22 may evaluate whether the generated driving route is appropriate for the mobility vehicle 40 to actually drive. To this end, the camera of the front terrain scanning unit 10 scans the surface image within the driving route of the mobility vehicle 40 in a step or operation S120 and transmits the surface image within the driving route to the controller 20. In a step or operation S130, the driving route generation unit 22 of the controller 20 determines whether the driving route generated in the step or operation S110 is appropriate for the mobility vehicle 40 to drive.

Determining whether the driving route is appropriate in the step or operation S130, according to an embodiment, is described in more detail with reference to FIG. 3.

As illustrated in FIG. 3, the step or operation S130 may start by allowing the driving route generation unit 22 to extract 3D points on the driving route from the surface image within the driving route in a step or operation S132. For example, the driving route generation unit 22 may extract the 3D pixel data positioned on the driving route along which the wheels 44 of the mobility vehicle 40 will pass from the surface image within the driving route. When the mobility vehicle 40 includes the left wheel 44 and the right wheel 44, the 3D pixel data positioned on the route for the left wheel 44 and the 3D pixel data positioned on the route for the right wheel 44 may be extracted.

When the 3D points for each wheel 44 are extracted, the driving route generation unit 22 converts the extracted 3D point coordinates (e.g., 3D pixel data) into 2D point coordinates (e.g., 2D pixel data) in a step or operation S134. In general, each wheel 44 can rotate to move forward and backward, but cannot move in a width direction of the mobility vehicle 40. In order to reduce an amount of computation for evaluating the driving route, the driving route generation unit 22 may convert the extracted 3D pixel data into the 2D pixel data in front-back and vertical directions. Since a conversion matrix for converting the 3D pixel data into the 2D pixel data is well known to those having ordinary skilled in the art, a detailed description thereof has been omitted.

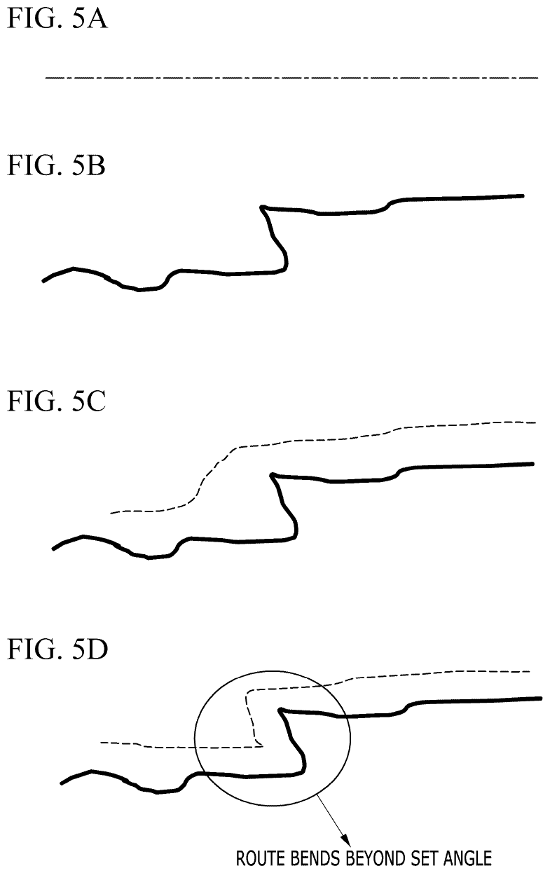

When the extracted 3D point coordinates are converted into the 2D point coordinates (including the depth data), the driving route generation unit 22 acquires the actual driving route for each wheel 44 according to the dynamic radius of each wheel 44 in a step or operation S136. For example, FIG. 5A illustrates the driving route for one wheel 44 generated in the step or operation S110, according to an embodiment. In FIGS. 5A-D, a left-right direction corresponds to the front-back direction and an up-down direction corresponds to the vertical direction (i.e., depth). The driving route for one wheel 44 illustrated in FIG. 5A is a straight route with no bends in the vertical direction. FIG. 5B illustrates that the 3D point coordinates extracted from the surface of the driving route in FIG. 5A are converted into the 2D point coordinates, according to an embodiment. FIG. 5B reflects the actual depth data of the driving route that is predicted to be flat.

The driving route on the curved surface in the vertical direction may vary depending on the size of the wheel 44. A dotted line in FIG. 5C illustrates the driving route for the wheel 44 with a relatively large dynamic radius, and a dotted line in FIG. 5D illustrates the driving route for the wheel 44 with a relatively small dynamic radius. As may be seen in FIGS. 5A and 5D, the actual driving route for the wheel 44 varies depending on the size of the corresponding wheel 44. Accordingly, the driving route generation unit 22 acquires the actual driving route for the wheel 44 using the depth data of the surface of the driving routes for each wheel 44 and the dynamic radius of the wheel 44.

When acquiring the actual driving route for the wheel 44, the driving route generation unit 22 determines whether the driving route for one wheel 44 is appropriate for driving in a step or operation S137. For example, as illustrated in FIG. 5D, when the dynamic radius of the wheel 44 is smaller than the depth of bend such that the actual driving route for the wheel 44 is expected to be bent to a preset angle or more, it may be determined that the actual driving route for the wheel 44 is not appropriate for driving. In this case, the method proceeds to a step or operation S170. Here, the preset angle may be 90°. However, the preset angle is not limited thereto.

However, as illustrated in FIG. 50, when the actual driving route for the wheel 44 is not bent to the preset angle or more, it may be determined that the actual driving route for the wheel 44 is appropriate for driving. In this case, the driving route generation unit 22 determines whether the driving route for the plurality of wheels 44 are appropriate for driving at step S138. Even if the driving route for each wheel 44 is appropriate for driving, the mobility vehicle 40 may not be appropriate for driving due to the terrain between the wheels 44. For example, as illustrated in FIG. 6B, when the road surface positioned between the wheels 44 is expected to protrude upward and collide with a bottom surface 42 of the mobility vehicle 40 between the wheels 44, the driving route generation unit 22 may determine that the driving route for the plurality of wheels 44 is not appropriate for driving. In addition, when one of the wheels 44 passes through a deep road surface and the road surface positioned between the wheels 44 is expected to collide with the bottom surface 42 of the mobility vehicle 40, the driving route generation unit 22 may determine that the driving route for the plurality of wheels 44 is not appropriate for driving. In this case, the method proceeds to the step or operation S170.

In contrast, as illustrated in FIG. 6A, the road surface positioned between the wheels 44 protrudes upward or one of the wheels 44 passes through the deep road surface, but when the road surface positioned between the wheels 44 is not expected to collide with the bottom surface 42 of the mobility vehicle 40 between the wheels 44, the driving route generation unit 22 may determine that the driving route for the plurality of wheels 44 is appropriate for driving. In this case, the method proceeds to a step or operation S140.

Referring back to FIG. 2, when it is determined in the step or operation S130 that the driving route is not appropriate for driving (“No” in the step or operation S137 or the step or operation S138), the driving route generation unit 22 regenerates the driving route in the step or operation S170, and the method returns to the step or operation S120 and scans the surface image within the regenerated driving route.

On the other hand, when it is determined at the step S130 that the driving route is appropriate for driving (“Yes” in the step or operation S137 and the step or operation S138), the driving route generation unit 22 generates the command to generate the driving command for the driving route and transmits the command to the driving command generation unit 24. The driving command generation unit 24 receives the command and generates the driving command for the actual driving route for each wheel 44 in the step or operation S140.

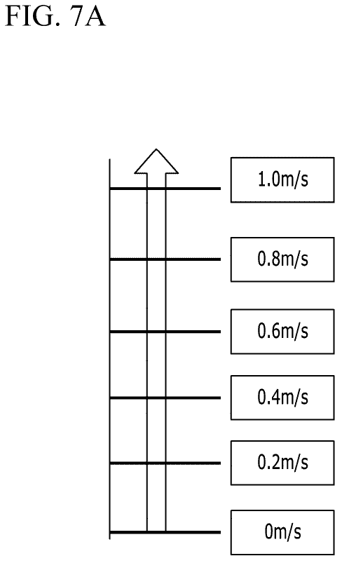

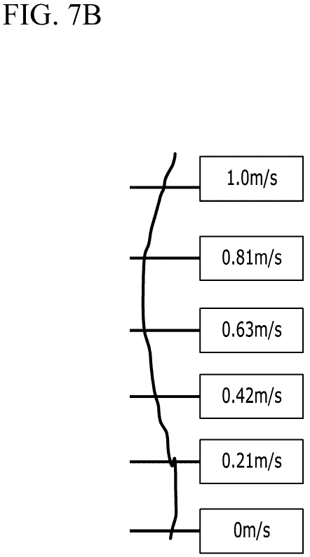

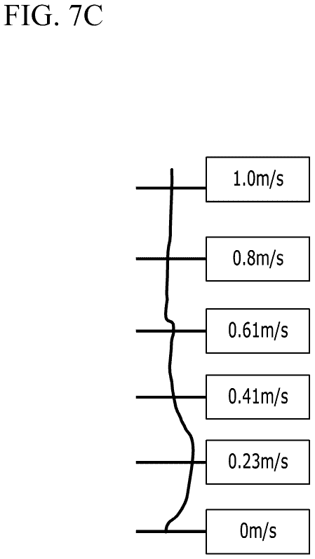

As illustrated in FIG. 4, the driving command generation unit 24 may first generate the speed command for the actual driving route for each wheel 44 in a step or operation S142. For example, FIG. 7A illustrates the target speed command of the mobility vehicle 40 when moving along the driving route generated in the step or operation S110, according to an embodiment. The mobility vehicle 40 moves along the driving route moving forward in a straight line, and as the mobility vehicle 40 moves, the target speed command is gradually increasing to 0 m/s, 0.2 m/s, 0.4 m/s, 0.6 m/s, 0.8 m/s, and 1.0 m/s. FIG. 7B illustrates the speed command when the left wheel 44 drives the actual driving route for the mobility vehicle 40 to move as illustrated at FIG. 7A and FIG. 7C illustrates the speed command when the right wheel 44 drives the actual driving route for the mobility vehicle 40 to move as illustrated in FIG. 7A, according to an embodiment. As the depth of the road surface over which the wheel 44 passes becomes deeper, the corresponding wheel 44 has to move more distance. Accordingly, the wheel 44 should move at a faster speed than the target speed of the mobility vehicle 40 in order for the mobility vehicle 40 to move at the target speed. Accordingly, the driving command generation unit 24 generates the speed command for the actual driving route for each wheel 44 based on the actual driving route for each wheel 44 and the target speed command of the mobility vehicle 40.

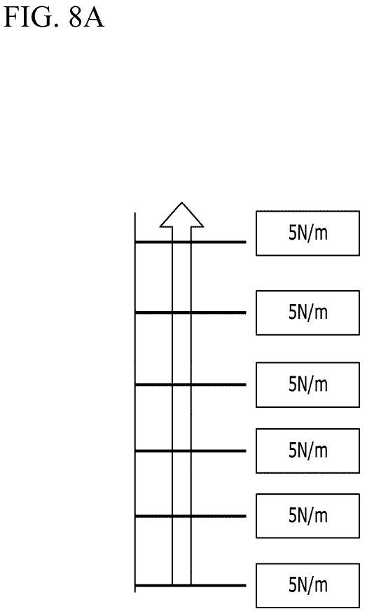

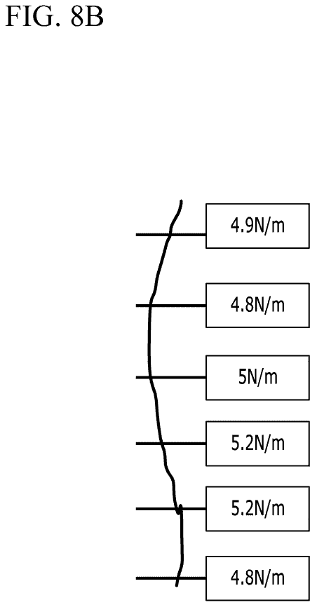

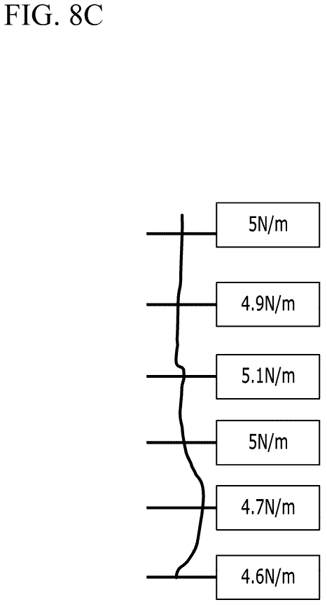

The driving command generation unit 24 may also generate the torque command for the actual driving route for each wheel 44 in a step or operation S144. For example, FIG. 8A illustrates the target torque command of the mobility vehicle 40 when moving along the driving route generated in the step or operation S110, according to an embodiment. The mobility vehicle 40 moves along the driving route heading forward in a straight line, and the target torque command for moving the mobility vehicle 40 is 5 N/m. FIG. 8B illustrates the torque command when the left wheel 44 moves along the actual driving route in order for the mobility vehicle 40 to move as illustrated in FIG. 8A and FIG. 8C illustrates the torque command when the right wheel 44 moves along the actual driving route in order for the mobility vehicle 40 to move as illustrated in FIG. 8A, according to an embodiment. When the wheel 44 passes the road surface curved downward, the corresponding wheel 44 may move with the torque smaller than the target torque, and when the wheel 44 passes the road surface curved upward, the corresponding wheel 44 may move with the torque larger than the target torque. Accordingly, the driving command generation unit 24 generates the torque command for the actual driving route for each wheel 44 based on the actual driving route for each wheel 44 and the target torque command of the mobility vehicle 40.

Referring back to FIG. 2, when the driving command for the actual driving route for each wheel 44 is generated, the driving command generation unit 24 may determine whether the generated driving command is appropriate in a step or operation S150. For example, when the actual driving route for one wheel 44 includes a bump and the torque required to go over the bump exceeds a maximum torque of the driving unit 30, the driving command generation unit 24 determines that the driving command for the actual driving route of each wheel 44 is not appropriate, and the method proceeds to the step S170 such that the driving route generation unit 22 regenerates the driving route for each wheel 44.

On the other hand, when the driving command for the actual driving route for each wheel 44 is determined to be appropriate in the step or operation S150, the driving command generation unit 24 controls the driving unit 30 according to the driving command in a step or operation S160. Accordingly, the speed of the driving unit 30 is controlled according to the speed command, and the torque of the driving unit 30 is controlled according to the torque command.

While the present disclosure has been described in connection with several embodiments, it should be understood that the disclosure is not limited to the disclosed embodiments. On the contrary, the disclosure is intended to cover various modifications and equivalent arrangements included within the spirit and scope of the appended claims.

What is claimed is:

1. A system for controlling driving of a mobility vehicle, the system comprising:
a front terrain scanning unit configured to detect light detection and ranging (LiDAR) point data in front of the mobility vehicle and scan a surface image in front of the mobility vehicle;
a driving unit configured to provide power to move the mobility vehicle; and
a controller configured to:
store a specification of the mobility vehicle including a dynamic radius of each wheel, generate a driving route for the mobility vehicle using the LiDAR point data,
detect depth data of a surface based on the surface image in front of the mobility vehicle,
acquire an actual driving route for each wheel using the depth data of the surface within the driving route for each wheel and the dynamic radius of each wheel of the mobility vehicle,
generate a driving command for the actual driving route for each wheel, and
control an operation of the driving unit according to the driving command.

2. The system of claim 1, wherein the controller is further configured to:
determine whether the driving route for one wheel is appropriate for driving; and
determine whether driving routes of a plurality of wheels are appropriate for driving.

3. The system of claim 2, wherein the controller is configured to generate the driving command for the actual driving route for each wheel in response to determining that the driving route for one wheel is appropriate for driving and that the driving routes for the plurality of wheels are appropriate for driving.

4. The system of claim 2, wherein the controller is further configured to regenerate the driving route in response to determining that the driving route for one wheel is not appropriate for driving or determining that the driving routes for the plurality of wheels are not appropriate for driving.

5. The system of claim 2, wherein the controller is configured to determine that the driving route for one wheel is not appropriate for driving in response to determining that the actual driving route for the one wheel is expected to be bent to a preset angle or more.

6. The system of claim 2, wherein the controller is configured to determine that the driving routes for the plurality of wheels are not appropriate for driving in response to determining that a road surface positioned between wheels, among the plurality of wheels, is expected to collide with a bottom surface of the mobility vehicle.

7. The system of claim 1, wherein the controller is configured to generate the driving command for the actual driving route for each wheel at least by generating a speed command for the actual driving route for each wheel and generating a torque command for the actual driving route for each wheel.

8. The system of claim 7, wherein the controller is configured to generate the speed command for the actual driving route for each wheel based on the actual driving route for each wheel and a target speed command of the mobility vehicle.

9. The system of claim 7, wherein the controller is configured to generate the torque command for the actual driving route for each wheel based on the actual driving route for each wheel and a target torque command of the mobility vehicle.

10. The system of claim 1, wherein the controller is further configured to:
determine whether the driving command for the actual driving route for each wheel is appropriate; and
control the driving unit according to the driving command in response to determining that the driving command for the actual driving route for each wheel is appropriate.

11. The system of claim 10, wherein the controller is further configured to regenerate the driving route in response to determining that the driving command for the actual driving route for each wheel is not appropriate.

12. A method of controlling driving of a mobility vehicle, the method comprising:
detecting a light detection and ranging (LiDAR) point in front of the mobility vehicle by a front terrain scanning unit;
scanning a surface image in front of the mobility vehicle by the front terrain scanning unit;
generating, by a controller, a driving route for the mobility vehicle using LIDAR point data;
detecting, by the controller, depth data of a surface in the driving route based on the surface image in front of the mobility vehicle;
acquiring, by the controller, an actual driving route for each wheel using the depth data of the surface within the driving route for each wheel and a dynamic radius of each wheel of the mobility vehicle;
generating, by the controller, a driving command for the actual driving route for each wheel; and
controlling, by the controller, an operation of a driving unit according to the generated driving command.

13. The method of claim 12, further comprising:
determining, by the controller, whether the driving route for one wheel is appropriate for driving; and
determining, by the controller, whether driving routes for a plurality of wheels are appropriate for driving.

14. The method of claim 13, wherein generating the driving command for the actual driving route for each wheel includes generating, by the controller, the driving command in response to determining that the driving route for one wheel is appropriate for driving and that the driving routes for the plurality of wheels are appropriate for driving.

15. The method of claim 13, further comprising regenerating, by the controller, the driving route in response to determining that the driving route for one wheel is not appropriate for driving or determining that the driving routes for the plurality of wheels are not appropriate for driving.

16. The method of claim 12, wherein generating the driving command for the actual driving route for each wheel includes:
generating a speed command for the actual driving route for each wheel; and
generating a torque command for the actual driving route for each wheel.

17. The method of claim 16, wherein the speed command for the actual driving route for each wheel is generated based on the actual driving route for each wheel and a target speed command of the mobility vehicle.

18. The method of claim 16, wherein the torque command for the actual driving route for each wheel is generated based on the actual driving route for each wheel and a target torque command of the mobility vehicle.

19. The method of claim 12, further comprising:
determining, by the controller, that the driving command for the actual driving route for each wheel is appropriate; and
controlling the operation of the driving unit according to the driving command in response to determining that the driving command is appropriate for the actual driving route for each wheel.

20. The method of claim 19, further comprising regenerating, by the controller, the driving route in response to determining that the driving command for the actual driving route for each wheel is not appropriate.
